(19) United States
(12) Patent Application Publication
(10) Pub. No.: US 2020/0389325 A1
(43) Pub. Date: Dec. 10, 2020

(54) IN-VEHICLE-FUNCTION ACCESS CONTROL SYSTEM, IN-VEHICLE APPARATUS, AND IN-VEHICLE-FUNCTION ACCESS CONTROL METHOD

(71) Applicant: MITSUBISHI ELECTRIC CORPORATION, Tokyo (JP)

(72) Inventors: Junko NAKAJIMA, Tokyo (JP); Nobuaki MATOZAKI, Tokyo (JP); Yuya TAKATSUKA, Tokyo (JP); Yoshiko SHIOMOTO, Tokyo (JP)

(73) Assignee: MITSUBISHI ELECTRIC CORPORATION, Tokyo (JP)

(21) Appl. No.: 16/961,839

(22) PCT Filed: Feb. 21, 2018
(86) PCT No.: PCT/JP2018/006240

§ 371 Date: Jul. 13, 2020

(51) Int. Cl. H04L 9/32; H04L 9/08

(52) U.S. Cl. CPC H04L 9/3263; H04L 2209/84; H04L 9/0877

(57) ABSTRACT

An object is to reduce unauthorized use of an in-vehicle function by an unpermitted person. An in-vehicle function access control system includes: an encryption processing unit that encrypts an in-vehicle function program for executing an in-vehicle function being a function of an in-vehicle apparatus to acquire encrypted data; an encrypted data storage that stores the encrypted data; an authentication unit that performs authentication of a user; a decryption processing unit that decrypts the encrypted data into the in-vehicle function program after the authentication succeeds; and a program storage that stores the in-vehicle function program decrypted by the decryption processing unit after the authentication succeeds, the program storage being provided in the in-vehicle apparatus.

### TECHNICAL FIELD

The present invention relates to technology of controlling access to an in-vehicle function.

### BACKGROUND ART

There have hitherto been various in-vehicle systems, such as a car navigation system (for example, Patent Document 1) and an automated driving system.

### PRIOR ART DOCUMENTS

### Patent Documents

Patent Document 1: Japanese Patent Application Laid-Open No. 2016-029392

### SUMMARY

### Problem to be Solved by the Invention

Regarding such in-vehicle systems as above, techniques in which third parties attack vehicles by abusing in-vehicle functions installed in an in-vehicle apparatus have been known. From the perspective of attackers, a debug function in particular is an efficient attack path among the in-vehicle functions, because the debug function allows execution of programs and access to memory. Having the debug function attacked may pose high risks. The present invention is made in view of the problem described above, and has an object to reduce unauthorized use of an in-vehicle function by an unpermitted person.

### Means to Solve the Problem

An in-vehicle function access control system of the present invention includes: an encryption processing unit being configured to encrypt an in-vehicle function program for executing an in-vehicle function being a function of an in-vehicle apparatus to acquire encrypted data; an storage being configured to store the encrypted data; an authentication unit being configured to perform authentication of a user; a decryption processing unit being configured to decrypt the encrypted data into the in-vehicle function program after the authentication succeeds; and a program storage being configured to store the in-vehicle function program after the authentication succeeds, the program storage being provided in the in-vehicle apparatus.

### Effects of the Invention

According to the in-vehicle function access control system of the present invention, the encrypted data is stored in the storage while the in-vehicle function program is not stored therein before the authentication of the user succeeds. This allows for reduction of the use of the in-vehicle function by a person who does not undergo the authentication or a person who failed the authentication. These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a schematic diagram of an in-vehicle function access control system of a first embodiment.

FIG. 2 is a block diagram illustrating a configuration of the in-vehicle function access control system of the first embodiment.

FIG. 3 is a flowchart illustrating operation of the in-vehicle function access control system of the first embodiment.

FIG. 4 is a block diagram illustrating a configuration of an in-vehicle function access control system of a second embodiment.

FIG. 5 is a block diagram illustrating a configuration of a vehicle.

FIG. 6 is a configuration diagram of a vehicle communication apparatus of the second embodiment.

FIG. 7 is a configuration diagram of a management server of the second embodiment.

FIG. 8 is a configuration diagram of an IC card of the second embodiment.

FIG. 9 is a diagram illustrating an example of details of a management database.

FIG. 10 is a diagram illustrating an example of details of a key management data table.

FIG. 11 is a diagram illustrating an example of details of an in-vehicle function data table.

FIG. 12 is a diagram illustrating an example of details of a user authentication data table.

FIG. 13 is a diagram illustrating an example of details of a log information data table.

FIG. 14 is a flowchart illustrating operation of the in-vehicle function access control system of the second embodiment.

FIG. 15 is a flowchart illustrating details of encryption processing of the second embodiment.

FIG. 16 is a flowchart illustrating details of authentication information generation processing of the second embodiment.

FIG. 17 is a flowchart illustrating details of user authentication processing and use validity judgment processing of the second embodiment.

FIG. 18 is a flowchart illustrating details of function activation processing of the second embodiment.

FIG. 19 is a configuration diagram of a vehicle communication apparatus of a third embodiment.

FIG. 20 is a configuration diagram of an IC card of the third embodiment.

FIG. 21 is a flowchart illustrating details of function activation processing of the third embodiment.

FIG. 22 is a configuration diagram of a vehicle communication apparatus of a fourth embodiment.

FIG. 23 is a configuration diagram of a management server of the fourth embodiment.

FIG. 24 is a configuration diagram of a vehicle communication apparatus of a fifth embodiment.

FIG. 25 is a flowchart illustrating details of function activation processing of the fifth embodiment.

### DESCRIPTION OF EMBODIMENTS

### A. First Embodiment

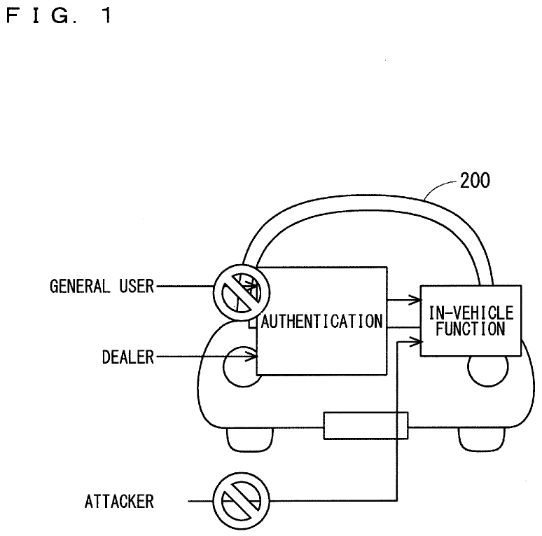

FIG. 1 is a schematic diagram of an in-vehicle function access control system of the first embodiment. The in-vehicle function access control system controls access to an in-vehicle function of an in-vehicle apparatus mounted on a vehicle 200. Here, the in-vehicle apparatus refers to an apparatus mounted on the vehicle 200 for fulfilling some function, and the in-vehicle function refers to a function to be fulfilled by the in-vehicle apparatus. The in-vehicle function access control system performs authentication, which is a procedure of confirming whether a user is a person permitted to use the in-vehicle function, and permits only a person who succeeded in the authentication to use the in-vehicle function. For example, the system permits only a vehicle dealer or supplier to pass the authentication, and prohibits a general user who fails the authentication or an attacker who attempts to use the in-vehicle function by circumventing the authentication from using the in-vehicle function.

Here, the in-vehicle function to be subject to access restriction may be any function as long as the function is included in the in-vehicle apparatus. However, because there are known techniques for attacking vehicles by abusing a maintenance function or a debug function in particular, there is a particularly high necessity for restricting access to those functions. The maintenance function is a function for performing maintenance of a vehicle, and the debug function is part of the maintenance function and is a function for performing various error checks, for example.

<A-1. Configuration>

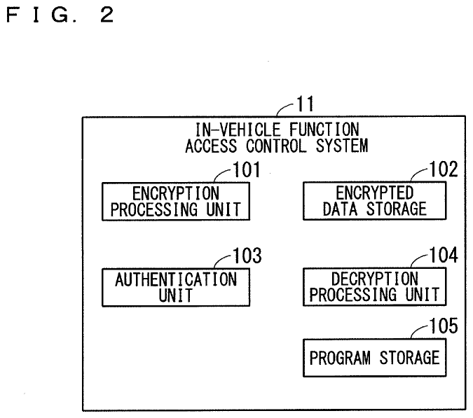

FIG. 2 is a block diagram illustrating a configuration of an in-vehicle function access control system 11 of the first embodiment. The in-vehicle function access control system 11 includes an encryption processing unit 101, an encrypted data storage 102, an authentication unit 103, a decryption processing unit 104, and a program storage 105.

The encryption processing unit 101 encrypts an in-vehicle function program to create encrypted data. The in-vehicle function program is a program for executing the in-vehicle function. In this specification, a non-encrypted in-vehicle function program is hereinafter simply referred to as an “in-vehicle function program”, and an encrypted in-vehicle function program is herein referred to as “encrypted data”.

The encrypted data is stored in the encrypted data storage 102.

The authentication unit 103 performs user authentication.

After the authentication performed by the authentication unit 103 succeeds, the decryption processing unit 104 decrypts the encrypted data to acquire the in-vehicle function program.

The program storage 105 is provided in the in-vehicle apparatus, and stores the in-vehicle function program decrypted by the decryption processing unit 104. Note that the encrypted data storage 102 and the program storage 105 may be the same storage.

<A-2. Operation>

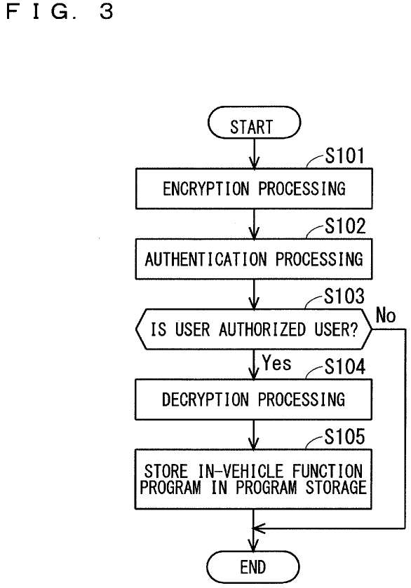

FIG. 3 is a flowchart illustrating operation of the in-vehicle function access control system 11. Operation of the in-vehicle function access control system 11 will be described below in the order illustrated in FIG. 3.

First, the encryption processing unit 101 encrypts an in-vehicle function program to create encrypted data. The processing is referred to as encryption processing (Step S101). The encrypted data created in Step S101 is stored in the encrypted data storage 102.

Next, the authentication unit 103 performs user authentication processing (Step S102). If it is confirmed that the user is an authorized user in the authentication processing (Yes in Step S103), the decryption processing unit 104 decrypts the encrypted data to acquire the in-vehicle function program (Step S104). Then, the decrypted in-vehicle function program is stored in the program storage 105 (Step S105).

In contrast, if the user is not an authorized user (No in Step S103), the in-vehicle function access control system 11 ends the processing without decrypting the encrypted data.

<A-3. Effect>

As described above, the in-vehicle function access control system 11 of the first embodiment includes: the encryption processing unit 101 that encrypts an in-vehicle function program for executing an in-vehicle function being a function of the in-vehicle apparatus to acquire encrypted data; the encrypted data storage 102 that stores the encrypted data; the authentication unit 103 that performs authentication of a user; the decryption processing unit 104 that decrypts the encrypted data into the in-vehicle function program after the authentication succeeds; and the program storage 105 that stores the in-vehicle function program decrypted by the decryption processing unit after the authentication succeeds, the program storage being provided in the in-vehicle apparatus.

Further, the in-vehicle function access control method of the first embodiment includes: encrypting an in-vehicle function program for executing an in-vehicle function being a function of an in-vehicle apparatus to acquire encrypted data; storing the encrypted data in a storage; performing authentication of a user; decrypting the encrypted data into the in-vehicle function program after the authentication succeeds; and storing the in-vehicle function program being decrypted after the authentication succeeds.

According to these configurations, only when the authentication of the user succeeds, the encrypted data is decrypted into the in-vehicle function program and then stored in the program storage 105. Accordingly, the user can use the in-vehicle function only when the user succeeds in the authentication. A user not permitted to use the in-vehicle function fails the authentication, and thus cannot use the in-vehicle function. Further, even if an attacker attempts to use the in-vehicle function by circumventing the authentication, the attacker cannot use the in-vehicle function because the program storage 105 does not store the in-vehicle function program in such a case.

### B. Second Embodiment

<B-1. Configuration>

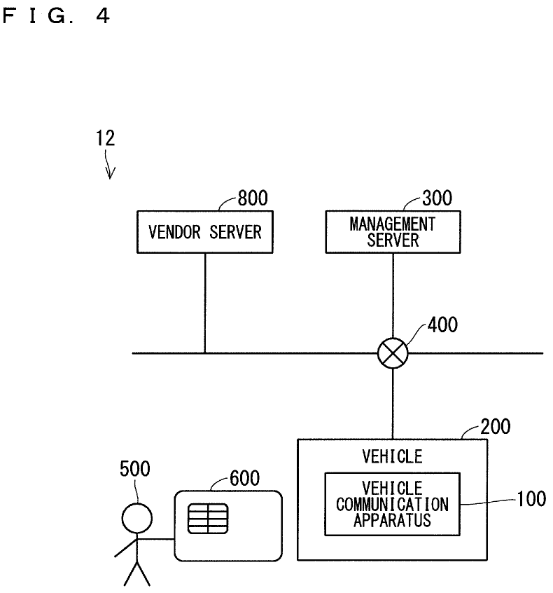

FIG. 4 is a block diagram illustrating a configuration of an in-vehicle function access control system 12 of the second embodiment. The in-vehicle function access control system 12 includes a vehicle communication apparatus 100 mounted on the vehicle 200, a management server 300, an IC card 600, and a vendor server 800. FIG. 4 illustrates only one of each component of the in-vehicle function access control system 12, but the number of each component may be more than one.

The vehicle 200, the management server 300, and the vendor server 800 communicate with each other via a network 400. One specific example of the network 400 is the Internet.

The IC card 600 stores user authentication information generated by the management server 300. Note that the IC card 600 is an example of a terminal used by a user 500 of the in-vehicle function, i.e., a user terminal. Although another device having an equivalent function, such as a mobile terminal or a USB token, is also assumable as the user terminal, the description of this specification adopts a user terminal as the IC card.

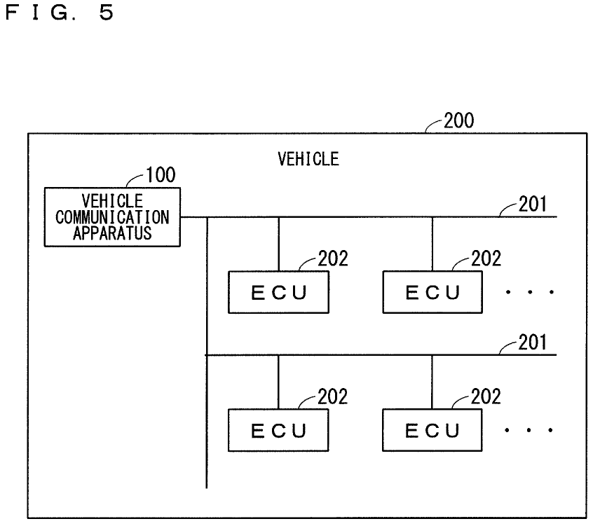

As illustrated in FIG. 5, the vehicle communication apparatus 100 and a plurality of intercommunicating electric control units (ECUs) 202 are mounted on the vehicle 200. The plurality of ECUs 202 and an in-vehicle network 201 are connected via the in-vehicle network 201 in conformity to communication protocols such as the Controller Area Network (CAN) or Flexray. The in-vehicle function of the vehicle communication apparatus 100 is subject to access restriction implemented by the in-vehicle function access control system 12.

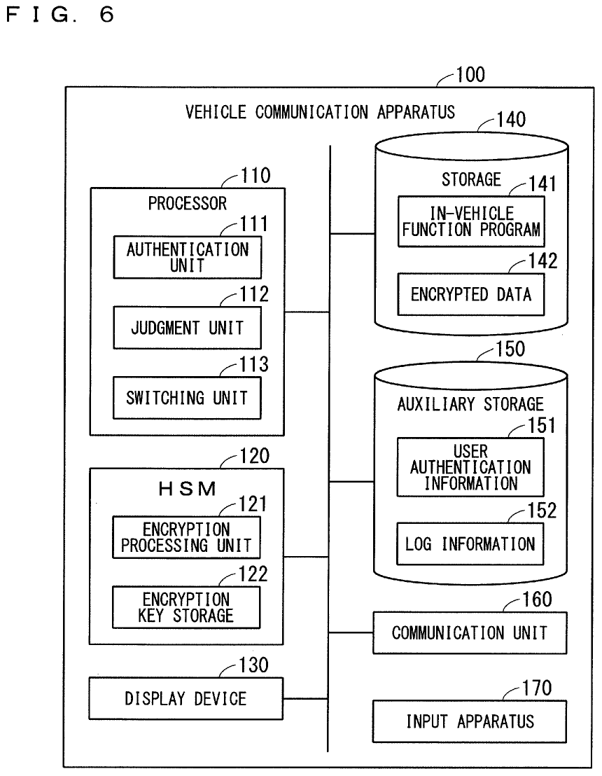

FIG. 6 is a block diagram illustrating a configuration of the vehicle communication apparatus 100. The vehicle communication apparatus 100 performs authentication processing for a would-be user of the in-vehicle function. If the authentication succeeds, i.e., only when it is successfully confirmed that the would-be user is an authorized user, the vehicle communication apparatus 100 decrypts encrypted data into an in-vehicle function program, and renders the in-vehicle function available.

The vehicle communication apparatus 100 is a computer including pieces of hardware, such as a processor 110, a hardware security module (HSM) 120, a display device 130, a storage 140, an auxiliary storage 150, a communication unit 160, and an input apparatus 170, and is an in-vehicle apparatus.

The processor 110 is connected to other pieces of hardware via a signal line. The processor 110 is an integrated circuit (IC) that performs arithmetic processing, and controls other pieces of hardware. Specifically, the processor 110 is a central processing unit (CPU), a digital signal processor (DSP), or a graphics processing unit (GPU).

The processor 110 includes an authentication unit 111, a judgment unit 112, and a switching unit 113. The authentication unit 111 performs user authentication. The judgment unit 112 judges use validity of the in-vehicle function with respect to a would-be user who has been confirmed to be an authorized user through the user authentication. If the authentication unit 111 confirms that the would-be user is an authorized user and the judgment unit 112 judges that the use of the in-vehicle function is valid, the switching unit 113 replaces a dummy program stored in the storage 140 with the in-vehicle function program and renders the in-vehicle function available.

The HSM 120 includes an encryption processing unit 121 and an encryption key storage 122. The encryption key storage 122 securely stores encryption keys. The encryption processing unit 121 performs encryption arithmetic by using an encryption key stored in the encryption key storage 122, and encrypts the in-vehicle function program.

The display device 130 is a device for displaying images or the like, and is a liquid crystal display, for example. The display device 130 is also referred to as a monitor.

The storage 140 is random access memory (RAM), for example, and stores in-vehicle function programs 141 for executing the in-vehicle function of the vehicle communication apparatus 100, and encrypted data 142, which are encrypted results of the in-vehicle function programs. In other words, the storage 140 serves as an encrypted data storage that stores encrypted data and a program storage that stores in-vehicle function programs.

The auxiliary storage 150 is a non-volatile storage, and specifically is read only memory (ROM), a hard disk drive (HDD), or flash memory. The auxiliary storage 150 stores user authentication information 151 and log information 152.

The communication unit 160 is an apparatus that performs communication, and includes a receiver and a transmitter. Specifically, the communication unit 160 is a communication chip or a network interface card (NIC).

The input apparatus 170 serves as a reception unit that receives input to the vehicle communication apparatus 100.

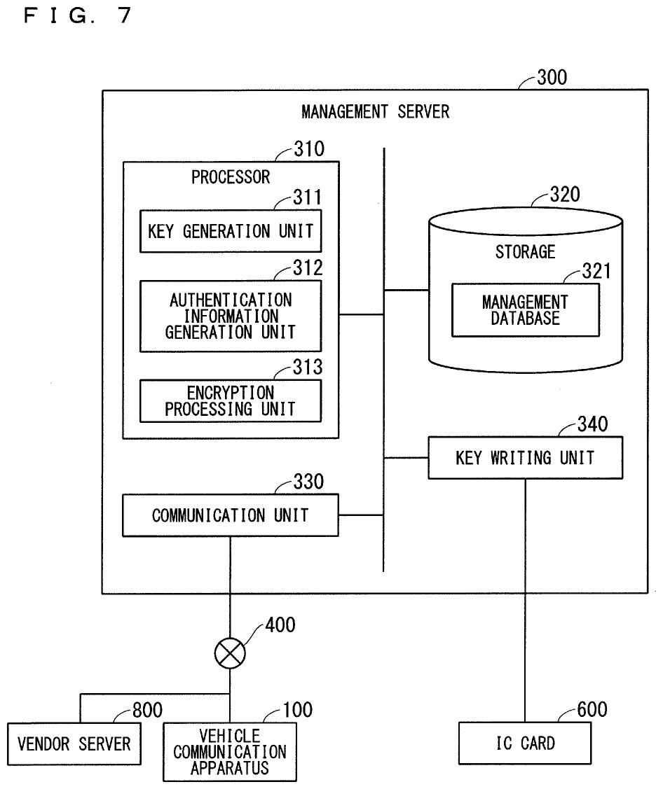

FIG. 7 is a block diagram illustrating a configuration of the management server 300. The management server 300 is a computer including pieces of hardware, such as a processor 310, a storage 320, a communication unit 330, and a key writing unit 340.

Hardware configurations of the processor 310, the storage 320, and the communication unit 330 are similar to those of the processor 110, the storage 140, and the communication unit 160 of the vehicle communication apparatus 100. Note that the vehicle communication apparatus 100 is a computer for an embedded device, while the management server 300 is a computer fulfilling a function as a server. Accordingly, the management server 300 is a computer having much higher computing performance than the vehicle communication apparatus 100.

The processor 310 includes a key generation unit 311, an authentication information generation unit 312, and an encryption processing unit 313. The key generation unit 311 generates keys necessary for user authentication (hereinafter referred to as authentication keys). The authentication information generation unit 312 generates user authentication information other than the authentication keys. The encryption processing unit 313 encrypts in-vehicle function programs.

The storage 320 includes a management database 321.

The communication unit 330 is connected with the vendor server 800 and the vehicle communication apparatus 100 via the network 400.

The key writing unit 340 writes the authentication keys generated by the key generation unit 311 in the IC card 600.

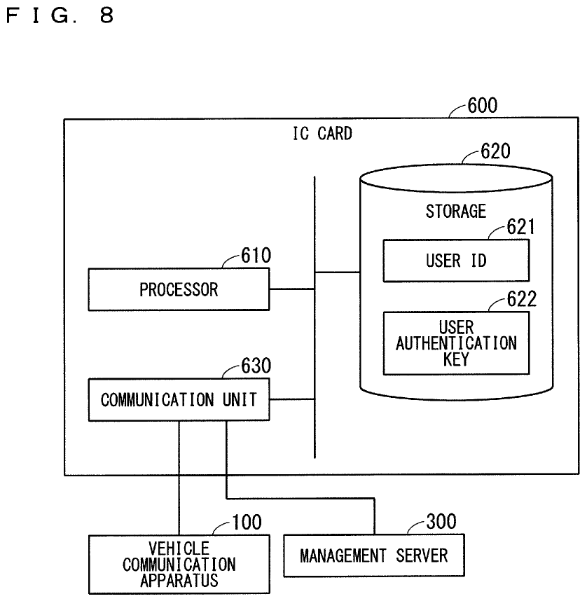

FIG. 8 is a block diagram illustrating a configuration of the IC card 600. The IC card 600 includes a processor 610, a storage 620, and a communication unit 630. Hardware configurations of the processor 610, the storage 620, and the communication unit 630 are similar to those of the processor 110, the storage 140, and the communication unit 160 of the vehicle communication apparatus 100.

The storage 620 stores data used in the IC card 600. For example, the storage 620 stores a user ID 621 and a user authentication key 622.

The communication unit 630 communicates data used in the IC card 600. For example, the communication unit 630 receives the user ID 621 and the user authentication key 622 from the management server 300 when the IC card 600 is issued or updated. Further, the communication unit 630 transmits and receives data necessary for user authentication to and from the vehicle communication apparatus 100.

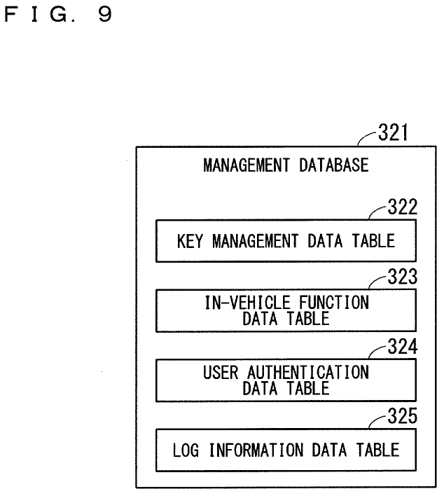

FIG. 9 illustrates an example of details of the management database 321 included in the storage 320 of the management server 300. The management database 321 includes a key management data table 322, an in-vehicle function data table 323, a user authentication data table 324, and a log information data table 325.

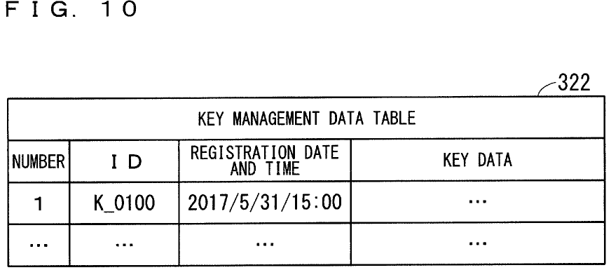

FIG. 10 illustrates an example of details of the key management data table 322. The key management data table 322 includes information of a key ID, a registration date and time, and key data. The key management data table 322 is used to register an authentication key ID and its key data associated with a user ID issued by the management server 300, and centrally manage a life cycle including update, invalidation, etc. of those pieces of data. Further, the key management data table 322 also includes information of an ID, registration date and time, and key data of an encryption key for data encryption that is used to encrypt the in-vehicle function program. In other words, the key management data table 322 is used to register and manage encryption keys.

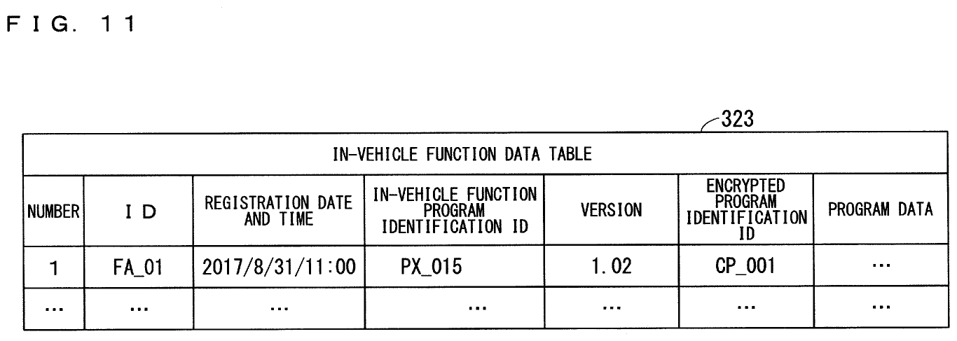

FIG. 11 illustrates an example of details of the in-vehicle function data table 323. The in-vehicle function data table 323 includes information such as a data ID, registration date and time, an in-vehicle function program identification ID as an ID for identifying an in-vehicle function program, a version of the in-vehicle function program, an encrypted program identification ID as an ID for identifying an encrypted program, and a vehicle function program data. The in-vehicle function data table 323 is used to centrally manage in-vehicle function programs to be protected by the in-vehicle function access control system 12 on the management server 300.

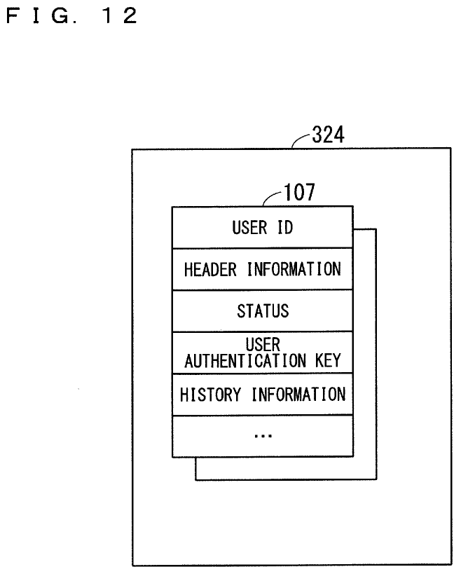

FIG. 12 illustrates an example of details of the user authentication data table 324. The user authentication data table 324 includes a plurality of pieces of user authentication information 107 that are prepared for each user. The user authentication information 107 includes use information related to a user ID, header information, a status, a user authentication key, and a use history. The user authentication key may be either a public key or a symmetric-key. The status indicates a user authentication status. For example, when the user authentication is invalidated, such information is shown as the status.

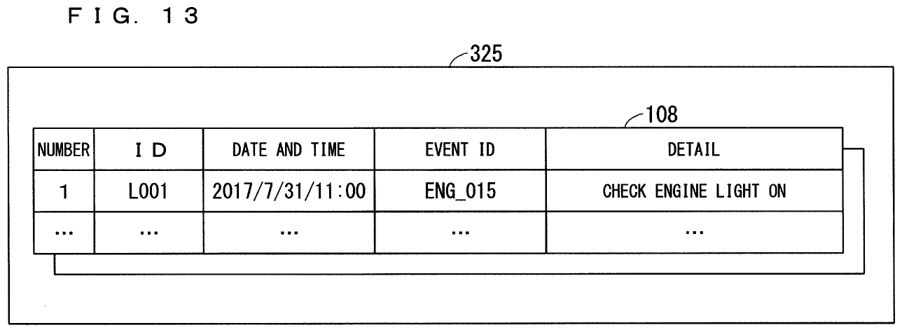

FIG. 13 illustrates an example of details of the log information data table 325. The log information data table 325 includes a plurality of pieces of log information 108. The log information 108 includes information such as a log ID, date and time, an event ID, and its detail. The log information 108 is collected and stored for each vehicle 200.

<B-2. Operation>

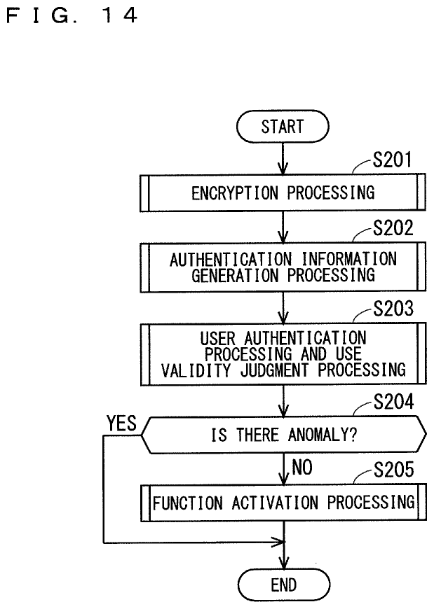

Operation of the in-vehicle function access control system 12 will be described in the order illustrated in FIG. 14.

First, the management server 300 encrypts an in-vehicle function program by using the encryption processing unit 313 to acquire encrypted data (Step S201). The processing in this step is referred to as encryption processing. The encryption processing is performed when the vehicle 200 and the vehicle communication apparatus 100 are manufactured or when software for the in-vehicle function is updated after shipping.

Next, the management server 300 generates an authentication key by using the key generation unit 311, generates other authentication information by using the authentication information generation unit 312, and stores the generated authentication key and authentication information in the IC card 600 and the management database 321 (Step S202). The processing in this step is referred to as authentication information generation processing.

Next, the vehicle communication apparatus 100 performs user authentication processing by using the authentication unit 111. If the authentication succeeds, the judgment unit 112 further performs use validity judgment processing regarding the function by using information such as a log (Step S203).

Then, if there is no anomaly in the user authentication processing or the use validity judgment processing (No in Step S204), the vehicle communication apparatus 100 decrypts the encrypted data by using the encryption processing unit 121, and sets the in-vehicle function available (Step S205). The processing in this step is referred to as function activation processing. The vehicle communication apparatus 100 performs processing of rendering the state of the available in-vehicle function back to the original state after the user finishes using the in-vehicle function or after a predetermined time period passes from the function activation.

Note that, if there is anomaly in the user authentication processing or the use validity judgment processing (Yes in Step S204), the processing of the in-vehicle function access control system 12 ends without the vehicle communication apparatus 100 performing the function activation processing.

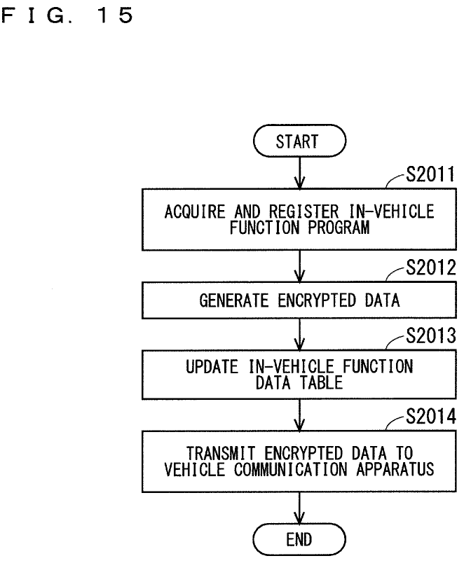

FIG. 15 is a flowchart illustrating details of the encryption processing (Step S201 of FIG. 14). The details of the encryption processing will be described below in the order illustrated in FIG. 15. First, the communication unit 330 of the management server 300 acquires an in-vehicle function program from the vendor server 800 via a secure network 400. The acquired in-vehicle function program is stored in the management database 321 of the storage 320, and is registered in the in-vehicle function data table 323 (Step S2011). Although the description herein concerns a method of acquiring an in-vehicle function program via the network 400, the management server 300 may acquire the in-vehicle function program by means of secure delivery involving a medium.

Next, the encryption processing unit 313 executes encryption of the in-vehicle function program registered in Step S2011 by using an encryption key for data encryption that is managed by ID in the key management data table 322, and generates encrypted data (Step S2012).

Then, the management server 300 updates the in-vehicle function data table 323 in the management database 321, and registers the encrypted data generated in Step S2012 (Step S2013).

Next, the communication unit 330 transmits the encrypted data to the vehicle communication apparatus 100, and the encrypted data is written in the storage 140 in the vehicle communication apparatus 100 (Step S2014). This step is performed when the vehicle communication apparatus 100 is manufactured in a factory or when software for the in-vehicle function is updated after shipping.

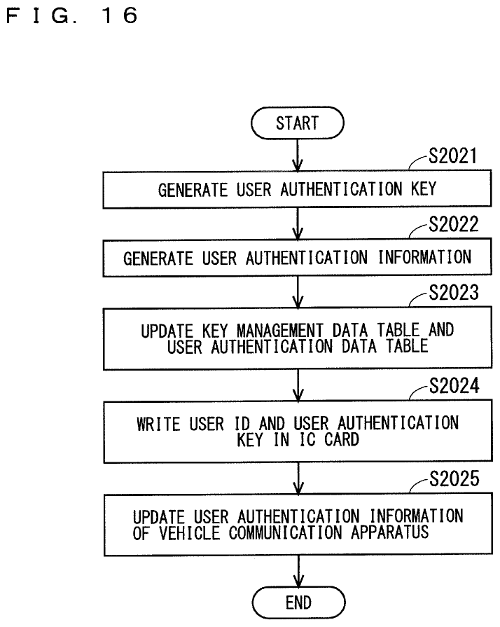

FIG. 16 is a flowchart illustrating details of the authentication information generation processing (Step S202 of FIG. 14). The details of the authentication information generation processing will be described below in the order illustrated in FIG. 16. First, the key generation unit 311 of the management server 300 generates a user authentication key 622 to be used in user authentication (Step S2021). Next, the authentication information generation unit 312 of the management server 300 generates user authentication information (Step S2022). The management server 300 stores the user authentication key 622 and the user authentication information generated respectively in Step S2021 and Step S2022 in the management database 321 of the storage 320, and updates the key management data table 322 and the user authentication data table 324 (Step S2023). Further, the key writing unit 340 writes a user ID 621 and the user authentication key 622 in the IC card 600 (Step S2024). Specifically, the key writing unit 340 stores the user ID 621 and the user authentication key 622 in the storage 620 of the IC card 600. The IC card 600 is issued only to specific users such as a dealer and a supplier, limiting users permitted to use the in-vehicle function. Next, the communication unit 330 transmits the user authentication information to the vehicle communication apparatus 100, and the vehicle communication apparatus 100 updates user authentication information 151 in the auxiliary storage 150 (Step S2025).

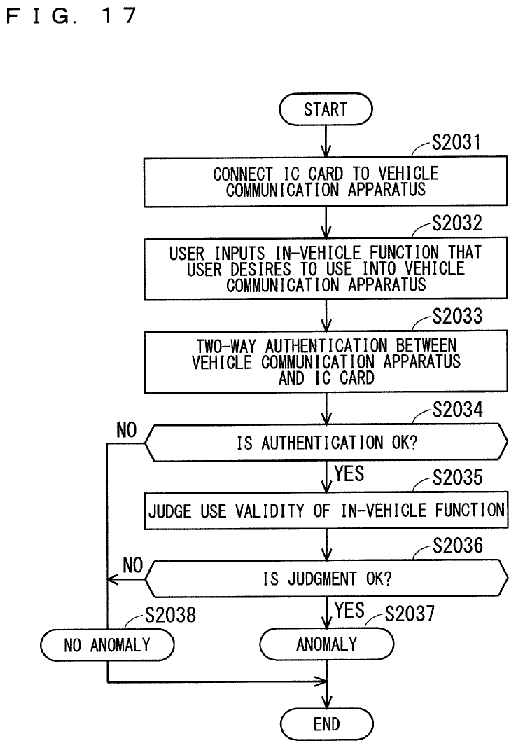

FIG. 17 is a flowchart illustrating details of the user authentication processing and the use validity judgment processing (Step S203 of FIG. 14). The details of the user authentication processing and the use validity judgment processing will be described below in the order illustrated in FIG. 17. First, the user connects the IC card 600 to the vehicle communication apparatus 100 (Step S2031). The connection may be performed by means of either contact connection or non-contact connection. However, communication paths and communication protocols are protected in terms of security. Next, the user inputs an in-vehicle function that the user desires to use via the input apparatus 170 (Step S2032). In this manner, the input apparatus 170 serves as a use request reception unit that receives a use request of an in-vehicle function from the user. Subsequently, the authentication unit 111 of the vehicle communication apparatus 100 performs two-way authentication with the IC card 600 (Step S2033). The authentication unit 111 performs the two-way authentication by using an authentication mechanism, specifically, existing technology such as protocols adopted as internationally standardized technology in ISO/IEC.

The authentication unit 111 judges an authentication result (Step S2034). If the authentication succeeds, the processing proceeds to Step S2035. If the authentication fails, the processing ends. In Step S2035, the judgment unit 112 searches the log information 152 stored in the auxiliary storage 150 or the log information data table 325 in the management database 321 of the management server 300 to refer to log information, and thereby judges use validity of the in-vehicle function. The judgment unit 112 may use either one or more judgment methods out of the following three examples of judgment methods.

The first judgment method is a method of analyzing correlation between user authentication processing and log information. It is often the case that some maintenance functions are performed due to occurrence of certain anomaly in a vehicle. Utilizing this fact, the judgment unit 112 analyzes correlation between log information that records vehicle anomalies and user authentication processing, and thereby judges use validity of the maintenance function. For example, if there is an anomaly in a vehicle at a past time point within a given period preceding from user authentication processing, the judgment unit 112 judges that the use of the in-vehicle function is valid. Further, the judgment unit 112 may judge use validity for each in-vehicle function as follows: even if there is an anomaly in a vehicle at a past time point within a given period preceding from user authentication processing, the judgment unit 112 judges that the use of the in-vehicle function is invalid if the anomaly has low relation to the in-vehicle function that the user desires to use.

The second judgment method is a method of making an inquiry to a cloud management server at the time of user authentication, and thereby judging use validity of a function that the user attempts to use. Some in-vehicle functions, such as the maintenance function, have an available period predetermined for examination that is carried out by vehicle manufacturers. The judgment unit 112 judges use validity based on the available period. Specifically, the judgment unit 112 judges that an attempt of use outside of the available period may be unauthorized access.

The third judgment method is a method of judging use validity based on an in-vehicle function use history of one specific user. The in-vehicle function use history of one specific user can be acquired from log information stored in the auxiliary storage 150 of the vehicle communication apparatus 100 or in the management database 321 of the management server 300. Further, identity of the user can be judged based on a user terminal. For example, if one specific user uses the in-vehicle function more than a predetermined number of times within a certain period or if one specific user simultaneously uses the in-vehicle function at different places, the judgment unit 112 can judge that the use is invalid.

If the judgment unit 112 judges that the use of the in-vehicle function is valid (Yes in Step S2036), the judgment unit 112 judges that there is no anomaly in the user authentication processing and the use validity judgment processing (Step S2037), and ends the processing. In contrast, if the authentication performed by the authentication unit 111 fails (No in Step S2034), the authentication unit 111 judges that there is anomaly in the user authentication processing (Step S2038), and ends the processing. Further, if the judgment unit 112 judges that the use of the in-vehicle function is invalid (No in Step S2036), the judgment unit 112 judges that there is anomaly in the use validity judgment processing (Step S2038), and ends the processing.

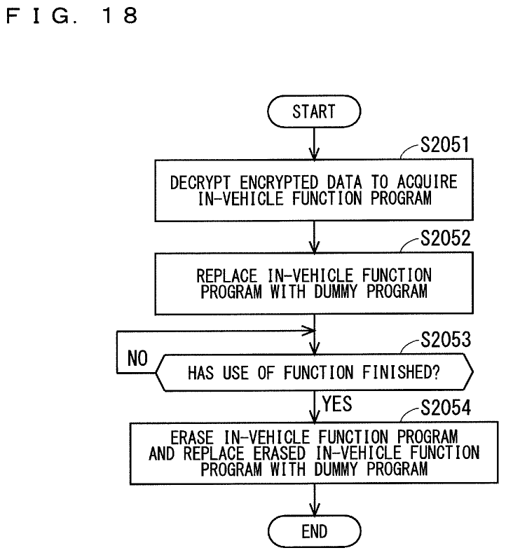

FIG. 18 is a flowchart illustrating details of the function activation processing (Step S205 of FIG. 14). The details of the function activation processing will be described below in the order illustrated in FIG. 18. First, the encryption processing unit 121 of the vehicle communication apparatus 100 decrypts encrypted data 142 by using an encryption key to acquire an in-vehicle function program (Step S2051). In other words, the encryption processing unit 121 serves as a decryption processing unit that decrypts encrypted data into an in-vehicle function program. Next, the vehicle communication apparatus 100 replaces a dummy program embedded in an execution program area of the storage 140 with the in-vehicle function program acquired in Step S2051 (Step S2052). Through the processing, the in-vehicle function is rendered available.

Next, the vehicle communication apparatus 100 judges whether the user finishes using the in-vehicle function (Step S2053). For example, the vehicle communication apparatus 100 makes the judgment of Step S2053 based on the fact that the user has pressed an end button (not shown) that is provided on the vehicle communication apparatus 100, that the time has reached a predetermined expiration date/time, or the like. For example, the expiration date/time is set as a specific due date, certain time after the in-vehicle function is rendered available, or the like.

After the user finishes using the in-vehicle function, the vehicle communication apparatus 100 erases the in-vehicle function program embedded in the execution program area of the storage 140, and replaces the erased in-vehicle function program with a dummy program (Step S2054). Through the processing, the in-vehicle function is rendered unavailable.

Note that, in the above description of the function activation processing, replacement between a dummy program and an in-vehicle function program switches the valid state and the invalid state of the in-vehicle function. However, such replacement with a dummy program is not necessarily required, as long as an in-vehicle function program is at least stored in the execution program area of the storage 140 when the in-vehicle function is valid, and the in-vehicle function program is erased from the execution program area of the storage 140 when the in-vehicle function is invalid. Note that the use of a dummy program brings about an advantage of facilitating rewriting in the execution program area.

<B-3. Effect>

The in-vehicle function access control system 12 of the second embodiment further includes the judgment unit 112 that judges use validity of the in-vehicle function to be used by the user. Then, the encryption processing unit 121 serving as a decryption processing unit decrypts the in-vehicle function program when the judgment unit 121 judges that use is valid. Accordingly, a user who succeeded in the authentication cannot use the in-vehicle function if the user's use is judged invalid.

The vehicle communication apparatus 100 of the second embodiment serves as an in-vehicle apparatus including an in-vehicle function. An in-vehicle function program for executing the in-vehicle function is encrypted. The vehicle communication apparatus 100 includes: the input apparatus 170 serving as a use request reception unit that receives a use request of the in-vehicle function from a user; and the storage 140 serving as a program storage that stores the in-vehicle function program being decrypted after the authentication of the user succeeds. Accordingly, the user can use the in-vehicle function only when the user succeeds in the authentication. A user not permitted to use the in-vehicle function fails the authentication, and thus cannot use the in-vehicle function. Further, even if an attacker attempts to use the in-vehicle function by circumventing the authentication, the attacker cannot use the in-vehicle function because the program storage 105 does not store the in-vehicle function program in such a case.

### C. Third Embodiment

In the second embodiment, the vehicle communication apparatus 100 includes encryption keys and decrypts encrypted data. In the third embodiment, by contrast, the IC card includes encryption keys and decrypts encrypted data. This allows for separate management, such as by managing encryption keys and encrypted data respectively in the IC card and the vehicle communication apparatus. Consequently, security is enhanced.

<C-1. Configuration>

The configuration of the in-vehicle function access control system of the third embodiment is similar to that of the in-vehicle function access control system of the second embodiment illustrated in FIG. 4. However, in the third embodiment, the configurations of the vehicle communication apparatus and the IC card are different from those of the second embodiment. Thus, the vehicle communication apparatus and the IC card will be described below, using the terms “vehicle communication apparatus 100B” and “IC card 600B”, respectively.

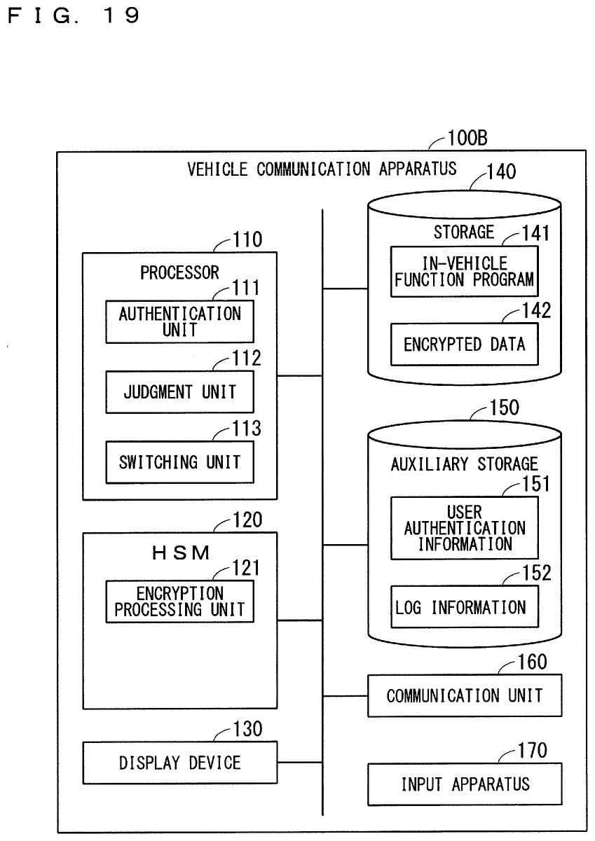

FIG. 19 is a configuration diagram of the vehicle communication apparatus 100B. The vehicle communication apparatus 100B is different from the vehicle communication apparatus 100 of the second embodiment in that the HSM 120 does not include an encryption key storage.

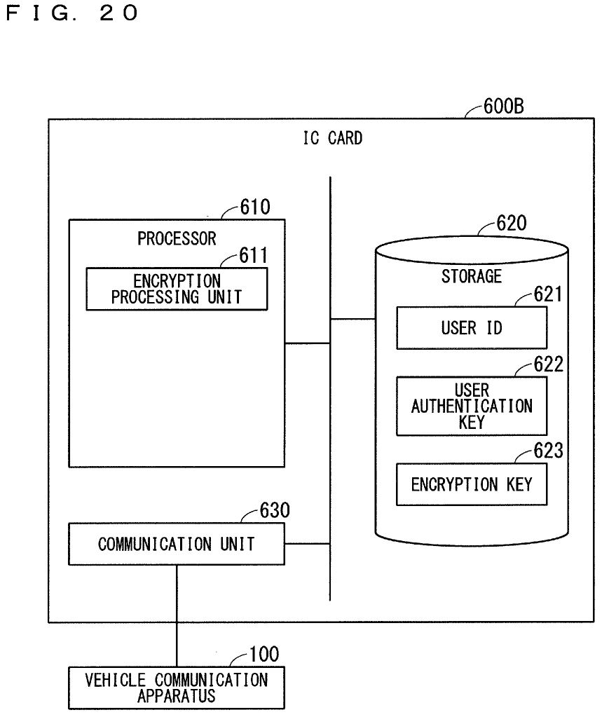

FIG. 20 is a configuration diagram of the IC card 600B. The IC card 600B is different from the IC card 600 of the second embodiment in that the processor 610 includes an encryption processing unit 611 and the storage 620 includes an encryption key 623. As described above, in the in-vehicle function access control system of the third embodiment, an encryption keys for encrypting in-vehicle function programs exist in the IC card 600B instead of the vehicle communication apparatus 100B.

<C-2. Operation>

Operation of the in-vehicle function access control system of the third embodiment is similar to the operation of the in-vehicle function access control system 12 of the second embodiment, of which procedure is illustrated in FIG. 14, and includes encryption processing, authentication information generation processing, user authentication processing, use validity judgment processing, and function activation processing. Among those types of processing, the encryption processing, the user authentication processing, and the use validity judgment processing are similar to those of the second embodiment, and thus detailed description of procedures thereof will be omitted.

The authentication information generation processing of the third embodiment is roughly the same as that of the authentication information generation processing of the second embodiment, of which procedure is illustrated in FIG. 16. Note that, in the second embodiment, the management server 300 writes a user ID and a user authentication key in the IC card 600, whereas in the third embodiment, the management server 300 writes an encryption key as well as a user ID and a user authentication key in the IC card 600B.

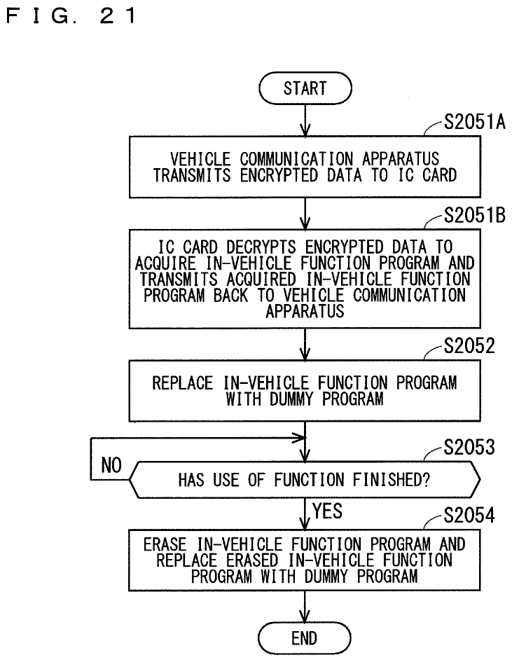

FIG. 21 is a flowchart illustrating details of the function activation processing of the third embodiment. The function activation processing of the third embodiment will be described below in the order illustrated in FIG. 21. First, the communication unit 160 of the vehicle communication apparatus 100B transmits encrypted data 142 stored in the storage 140 to the IC card 600B (Step S2051A). Next, the encryption processing unit 611 of the IC card 600B decrypts the encrypted data by using an encryption key, and transmits a resultant in-vehicle function program back to the vehicle communication apparatus 100B (Step S2051B). Subsequent processing of Steps S2052 to S2054 is similar to the processing of the second embodiment illustrated in FIG. 18, and thus description thereof will be omitted.

<C-3. Effect>

In the in-vehicle function access control system of the third embodiment, the IC card 600B serving as a user terminal includes the encryption processing unit 611. Adopting a configuration that the IC card 600B decrypts encrypted data allows for separate storage, such as a configuration that the vehicle communication apparatus 100B stores encrypted data and the IC card 600B stores encryption keys. Consequently, security is enhanced.

### D. Fourth Embodiment

In the second embodiment, the vehicle communication apparatus 100 performs the user authentication processing with the IC card 600. In the fourth embodiment, by contrast, the management server performs the user authentication processing with the IC card.

<D-1. Configuration>

The configuration of the in-vehicle function access control system of the fourth embodiment is similar to that of the in-vehicle function access control system of the second embodiment illustrated in FIG. 4. However, in the fourth embodiment, the configurations of the vehicle communication apparatus and the management server are different from those of the second embodiment. Thus, the vehicle communication apparatus and the management server will be described below, using the terms “vehicle communication apparatus 100C and “management server 300C, respectively.

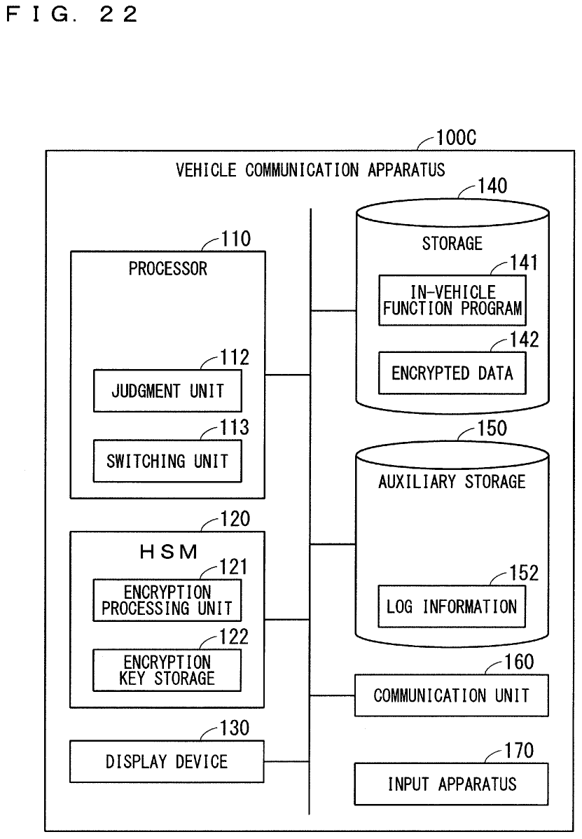

FIG. 22 illustrates a configuration of the vehicle communication apparatus 100C. The vehicle communication apparatus 100C is different from the vehicle communication apparatus 100 of the second embodiment in that the processor 110 does not include the authentication unit 111 and the user authentication information 151 is not stored in the auxiliary storage 150.

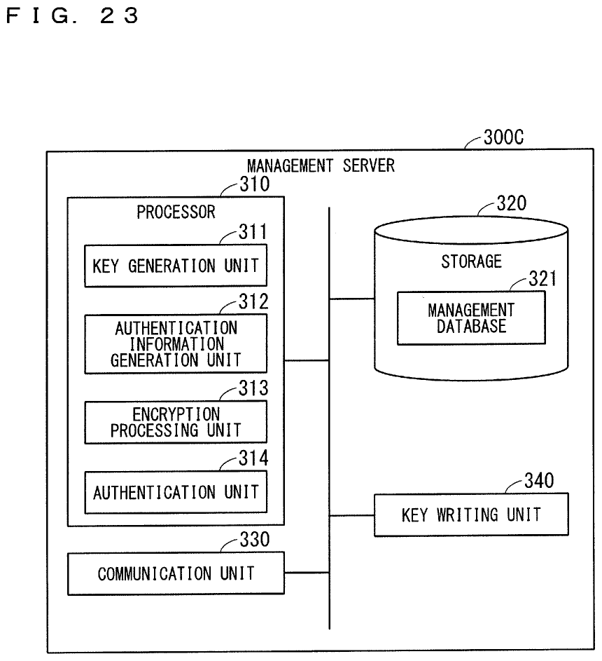

FIG. 23 illustrates a configuration of the management server 300C. In addition to the configuration of the management server 300 of the second embodiment, the management server 300C includes an authentication unit 314 in the processor 310.

<D-2. Operation>

Operation of the in-vehicle function access control system of the fourth embodiment is similar to the operation of the in-vehicle function access control system 12 of the second embodiment, of which procedure is illustrated in FIG. 14, and includes encryption processing, authentication information generation processing, user authentication processing, use validity judgment processing, and function activation processing. Among those types of processing, the encryption processing, the use validity judgment processing, and the function activation processing are similar to those of the second embodiment, and thus detailed description of procedures thereof will be omitted.

The authentication information generation processing of the fourth embodiment is the same as the authentication information generation processing of the third embodiment illustrated in FIG. 16, except that user authentication information is not transmitted from the management server 300C to the vehicle communication apparatus 100C.

The user authentication processing of the fourth embodiment is the same as the user authentication processing of the second embodiment illustrated in FIG. 17, except that the authentication unit 314 of the management server 300C performs two-way authentication with the IC card 600 via the vehicle communication apparatus 100C. Note that the description herein is based on an assumption that the IC card 600 supports only short-range radio communication, and the management server 300C performs two-way authentication with the IC card 600 via the vehicle communication apparatus 100C. When a user terminal supporting distant radio communication, such as a tablet terminal or a personal computer, is used, the management server 300C may perform two-way authentication by directly communicating with such a user terminal.

Note that the present embodiment may be combined with the third embodiment. Specifically, user authentication may be performed in the management server, and encrypted data may be decrypted in the IC card.

<D-3. Effect>

In the in-vehicle function access control system of the fourth embodiment, the authentication unit 314 is provided in the management server 300C that communicates with the vehicle communication apparatus 100C serving as an in-vehicle apparatus. This allows for simplification of the configuration of the vehicle communication apparatus 100C.

### E. Fifth Embodiment

In the second to fourth embodiments, the management server encrypts an in-vehicle function program and then transmits the encrypted data to the vehicle communication apparatus, and the vehicle communication apparatus decrypts the encrypted data into an in-vehicle function program after user authentication. In the present embodiment, by contrast, the management server encrypts an in-vehicle function program, stores the encrypted in-vehicle function program, and then transmits the encrypted data to the vehicle communication apparatus after user authentication. Except the above difference, the present embodiment is the same as the fourth embodiment.

<E-1. Configuration>

The configuration of the in-vehicle function access control system of the fifth embodiment is similar to that of the in-vehicle function access control system of the second embodiment illustrated in FIG. 4. However, in the fifth embodiment, the configuration of the vehicle communication apparatus is different from that of the second embodiment. Thus, the vehicle communication apparatus will be described below, using the term “vehicle communication apparatus 100D”.

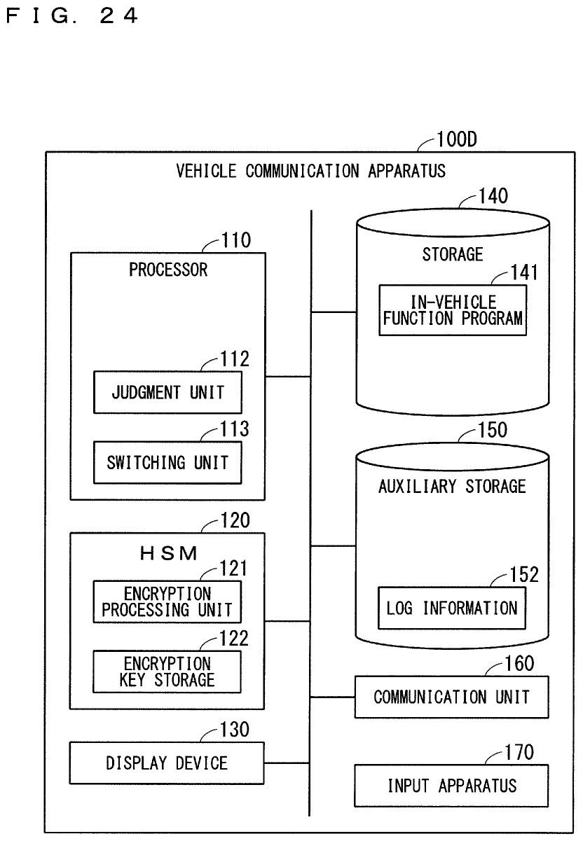

FIG. 24 is a configuration diagram of the vehicle communication apparatus 100D. The vehicle communication apparatus 100D is different from the vehicle communication apparatus 100C of the second embodiment in that the storage 140 does not store encrypted data.

<E-2. Operation>

Operation of the in-vehicle function access control system of the fifth embodiment is similar to the operation of the in-vehicle function access control system 12 of the second embodiment, of which procedure is illustrated in FIG. 14, and includes encryption processing, authentication information generation processing, user authentication processing, use validity judgment processing, and function activation processing. Among those types of processing, the authentication information generation processing, the user authentication processing, the use validity judgment processing, and the function activation processing are similar to those of the second embodiment, and thus detailed description of procedures thereof will be omitted.

In the encryption processing of the second embodiment, the management server 300 encrypts an in-vehicle function program, and then transmits the encrypted data to the vehicle communication apparatus (Step S2014 of FIG. 15). However, in the present embodiment, the management server 300 stores encrypted data in the storage 320 in advance, and transmits the encrypted data to the vehicle communication apparatus 100D at the time of the function activation processing. In other words, the storage 320 of the management server 300 serves as an encrypted data storage that stores encrypted data.

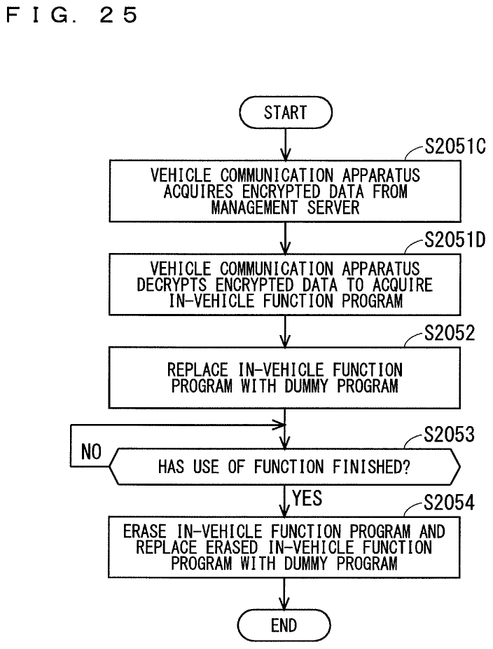

FIG. 25 is a flowchart illustrating details of the function activation processing of the fifth embodiment. The function activation processing of the fifth embodiment will be described below in the order illustrated in FIG. 25. First, the vehicle communication apparatus 100D acquires encrypted data from the management server 300 (Step S2051C). Next, the vehicle communication apparatus 100 decrypts the encrypted data to acquire an in-vehicle function program (Step S2051D). Subsequent processing of Steps S2052 to 2054 is similar to the processing of the second embodiment illustrated in FIG. 18, and thus description thereof will be omitted.

<E-3. Effect>

In the in-vehicle function access control system of the fifth embodiment, the storage 320 serving as an encrypted data storage is provided in the management server 300 that communicates with the vehicle communication apparatus 100D. Accordingly, the vehicle communication apparatus includes neither encrypted data nor an in-vehicle function program unless the authentication of the user succeeds. Consequently, security is enhanced in comparison with the second embodiment.

Note that the present embodiment may be combined with the third embodiment or the fourth embodiment. When the present embodiment is combined with the fourth embodiment, the vehicle communication apparatus 100 acquires encrypted data from the management server 300, and then transmits the encrypted data to the IC card 600. Then, the IC card 600 performs decryption processing on the encrypted data, and transmits a resultant in-vehicle function program back to the vehicle communication apparatus 100.

Note that, in the present invention, each embodiment can be freely combined, and each embodiment can be modified or omitted as appropriate within the scope of the invention.

While the invention has been shown and described in detail, the foregoing description is in all aspects illustrative and not restrictive. It is therefore understood that numerous unillustrated modifications can be devised without departing from the scope of the invention.

### EXPLANATION OF REFERENCE SIGNS

11, 12 In-vehicle function access control system, 100, 100B, 100C, 100D Vehicle communication apparatus, 101, 121, 313, 611 Encryption processing unit, 102 Encrypted data storage, 103 Authentication unit, 104 Decryption processing unit, 105 Program storage, 107, 151 User authentication information, 108, 152 Log information, 110, 310, 610 Processor, 111, 314 Authentication unit, 112 Judgment unit, 113 Switching unit, 120 HSM, 122 Encryption key storage, 130 Display device, 140, 320, 620 Storage, 141 In-vehicle function program, 142 Encrypted data, 150 Auxiliary storage, 160, 330, 630 Communication unit, 170 Input apparatus, 200 Vehicle, 201 In-vehicle network, 202 ECU, 300, 300C Management server, 311 Key generation unit, 312 Authentication information generation unit, 321 Management database, 322 Key management data table, 323 In-vehicle function data table, 324 User authentication data table, 325 Log information data table, 340 Key writing unit, 400 Network, 500 User, 600, 600B IC Card, 622 User authentication key, 623 Encryption key, 800 Vendor server

1. An in-vehicle function access control system comprising:
a processor to execute a program;
an encrypted data storage;
a program storage being provided in an in-vehicle apparatus mounted on a vehicle; and
a memory to store the program which, when executed by the processor, performs processes of,
encrypting an in-vehicle function program for executing an in-vehicle function being a function of the in-vehicle apparatus to acquire encrypted data,
performing authentication of a user, and
decrypting the encrypted data into the in-vehicle function program after the authentication succeeds,
the encrypted data storage storing the encrypted data,
the program storage storing the in-vehicle function program after the authentication succeeds.

2. The in-vehicle function access control system according to claim 1, wherein
when executed by the processor, the program further performs a process of judging use validity of the in-vehicle function to be used by the user, and
the in-vehicle function program is decrypted when it is judged that use of the in-vehicle function by the user is valid.

3. The in-vehicle function access control system according to claim 2, wherein
the use validity is judged with reference to log information recording anomaly of the vehicle.

4. The in-vehicle function access control system according to claim 2, wherein
the use validity is judged based on a predetermined available period of the in-vehicle function.

5. The in-vehicle function access control system according to claim 2, wherein
the use validity is judged with reference to log information recording a past authentication result of the user.

6. The in-vehicle function access control system according to claim 1, wherein
the in-vehicle function is a maintenance function or a debug function.

7. The in-vehicle function access control system according to claim 1, wherein
the authentication of the user is performed through communication with a user terminal used by the user,
the processor includes a first processor provided in the user terminal, and
the process of encrypting the in-vehicle function program to acquire the encrypted data is executed when the first processor executes the program.

8. The in-vehicle function access control system according to claim 1, wherein
the processor includes a second processor provided in a management server being configured to communicate with the in-vehicle apparatus, and
the authentication of the user is performed when the second processor executes the program.

9. The in-vehicle function access control system according to claim 1, wherein
the encrypted data storage is provided in a management server being configured to communicate with the in-vehicle apparatus.

10. An in-vehicle apparatus including an in-vehicle function, wherein
an in-vehicle function program for executing the in-vehicle function is encrypted, the in-vehicle apparatus comprising:
a receiver being configured to receive a use request of the in-vehicle function from a user; and
a program storage being configured to store the in-vehicle function program being decrypted after the authentication of the user succeeds.

11. An in-vehicle function access control method comprising:
encrypting an in-vehicle function program for executing an in-vehicle function being a function of an in-vehicle apparatus to acquire encrypted data;
storing the encrypted data in a storage;
performing authentication of a user;
decrypting the encrypted data into the in-vehicle function program after the authentication succeeds; and
storing the in-vehicle function program being decrypted after the authentication succeeds.
